(19) United States
(12) Patent Application Publication
(10) Pub. No.: US 2015/0179288 A1
(43) Pub. Date: Jun. 25, 2015

(54) Spherical Fuel Reactor

(71) Applicant: Zhengwei Li, Shenzhen (CN)

(72) Inventor: Zhengwei Li, Shenzhen (CN)

(21) Appl. No.: 14/374,525

(22) PCT Filed: Jul. 1, 2013
(86) PCT No.: PCT/CN2013/078569

§ 371 Date: Sep. 2, 2014

(30) Foreign Application Priority Data
Jul. 25, 2012 (CN) 2012102595807

(51) Int. Cl. G21C 3/04

(52) U.S. Cl. CPC G21C 3/04

(57) ABSTRACT

The present invention claims a nuclear reactor which can package the nuclear fuel and the coolant together in a spherical solid and transfer heat to the steam generator through the flow of spherical solid between the reactor vessel (1) and the steam generator (2) by two sets of mechanical transmission systems (4). The reactor is featured in high inherent safety, high outlet temperature parameter and full use of the nuclear fuel. It can be applied in many fields, such as power generation, hydrogen production, heating, liquefaction and gasification of coal and so on.

### TECHNICAL FIELD

The invention belongs to the field of nuclear reactor engineering research and design and relates to a spherical fuel reactor.

### BACKGROUND ART

Spherical fuel elements have been applied in the high temperature gas cooled reactor. Because of its ease of loading and refueling and good inclusive capability of radioactive materials, etc., it has been generally recognized. Molten salt reactor has good overall performance but its high corrosion at high temperature is difficult to solve.

### SUMMARY OF THE INVENTION

The spherical fuel reactor of the present invention is to package nuclear fuel and solid coolant together in a spherical solid to prepare a spherical fuel assembly and make the spherical solid circulate between the reactor and the steam generator through mechanical transfer system so as to transfer heat from the reactor to the steam generator.

Generally, it is believed that only liquid and gas can serve as reactor coolant. The spherical fuel reactor of the present invention adopts spherical solid as the coolant. The spherical solid has good rolling capacity. A large number of spherical solid particles flow together, which can exhibit some similar characteristics of liquid flow, especially when the particle size of spherical solid is small, its flow characteristics are very similar to that of liquid. Spherical fuel reactor is to make spherical solid particles flow up to down by means of its own weight in the reactor and spherical solid particles are lifted by transport means to the desired height for the upper and lower circular flow. The spherical fuel reactor transfers heat through the recycling flow of the spherical solid particles from the high temperature places to low temperature places. The nuclear fuel is packaged in spherical solid. The solid can well cover radioactive materials and can stop the spread of radioactive materials as well as is conducive to safety. This process of heat transfer not only has value in the reactor but also in other industries.

The mass flow feature of spherical solid particle has great relationship with their particle size. The smaller particle size is, the closer the flow feature and nature is to that of liquid. Spherical solid particles flow by their own rolling. Actually, under the action of gravity only those in contact with the wall surface roll and others at the top mainly move at the horizontal level. The smaller the particle size is, the smaller the porosity of the solid particles is and the better the thermal conductivity is. If the particle temperature is high, it needs to consider the heat transfer speed by radiation, which may be even faster than contact heat conduction. Spherical solid particle heat transfer speed is slower than that of water because the solid can not transfer heat by turbulent. The advantages of spherical solid as a coolant are that nuclear fuel can be dispersed in the solid so that the heat source is not overly concentrated at a certain point, which can compensate for the lack of heat transfer capacity. The local temperature of the reactor can not be too high. Thus, the reactor volumetric power density in case of coolant of spherical solid may be lower. The total volume of the reactor with same power may be larger than that of pressurized water reactor.

Some design can make a single nuclear fuel ball have its own inherent safety and control the number of the nuclear fuel inside the ball so that the speed of the heat generation can be controlled within certain limits. As a result, the nuclear fuel ball can transfer heat before itself temperature rises too high even in case of no other coolant. In the reactor, there are many coolant balls containing no nuclear fuel. These balls are also used to spread the heat of the reactor. Fuel balls transfer heat to the coolant balls by heat conduction and thermal radiation and these balls also have large reactor thermal margin. In accident situations, they can transfer heat to the outside of the reactor and can also well cover the fuel to improve the reactor safety. More solid materials may be placed outside the reactor vessel and make them keep good contact with the reactor vessel, so that heat can be transferred out of the reactor through the heat conduction and heat radiation and the reactor does not melt.

The main loop of spherical fuel reactor of the present invention consists of a reactor vessel, a steam generator and lifting and transfer devices, wherein the lower outlet height of the reactor is less than or equal to that of the steam generator. The reactor is provided with two sets of lifting and transfer devices to lift and transport the spherical solid from the lower outlet of the steam generator to the upper inlet of the reactor vessel and from the lower outlet of the reactor vessel to the upper inlet of the steam generator. After absorbing heat generated in the nuclear reaction in the reactor vessel, the spherical solid falls the lower outlet of the reactor vessel by gravity and the lifting and transfer devices transfer the ball to the steam generator inlet, spherical solid falls in the steam generator by its own gravity and transfer heat to water on the cold side. After it drops out of the steam generator, the lifting and transfer devices transfer the ball to upper inlet of the reactor vessel. Such circulation can transfer the heat from the reactor to the steam generator. Spherical fuel reactor is applicable to thermal neutron reactors and fast neutron reactors and can be separately designed into two types of reactors.

Lifting and transfer devices are similar to escalator. In order to reduce damage to the nuclear fuel elements, rolling of the ball should be avoided. Two sets of lifting and transfer devices are adopted. The ball may suffer collision only under gravity. Mechanical transmission system should adopt large cross-section and low-flow plan. Low flow rate can reduce friction to the ball, which is adapted to the flow characteristics of spherical solid particles. Due to the high temperature of the ball, anti-high temperature hoist should be used. Lifting and transfer devices should be of good sealability. The reactor runs nearly at atmospheric pressure but it still needs to be filled with protective gas for oxygen gas isolation so that the main loop can maintain a closed environment and the closed loop can be used as a radioactive security barrier. Although the use of a set of lifting and transfer device is feasible, long-term fuel ball rolling will increase wear to impact of the service life of the ball. Thus, the lifting and transfer device should be designed to be able to transfer smaller particle size of the solid particles and conveyor belt made of steel wire cloth can be used. In order to prevent the loss of solid particles from the gap on both sides of the conveyor belt, the fence is provided on both sides of the conveyor belt and it can move with the conveyor belt. The conveyor belt which is featured in low middle and high sides can also be designed to prevent solid particles from flowing to the two sides. Efforts should also be made to prevent solid particles from flowing into the gap between the moving parts and the stationary parts, affecting the safe operation of the transmission system. In order to minimize the impact force of the fuel ball at the top of the reactor vessel by gravity, the transmission system is also designed to have a downward inclination so that the fuel balls slowly flow downward and the lower end of the transmission system is also designed to have a certain angle of inclination so that the fuel balls does not flow backward, which can be achieved by design of particular guide rails. The upper inlet of the reactor vessel is provided with guide channel, so that the ball can flow slowly downward. This transmission system has certain requirements for the diameter of the solid particles. Too small ones or too close to the powdered solids may not be suitable for such a transmission device because it is difficult to ensure no loss of the transfer process. The conveyor belt should be designed to have certain flexibility in order to reduce the collision damage between fuel balls and the conveyor belt and steel wire cloth can satisfy this requirement. Mechanical transmission system requires cooling measures to prevent decrease in mechanical strength due to too much rise of the temperature. The two sets of lifting and transfer devices should maintain the same flow rate. It is necessary to maintain coordination between them.

The diameter of control rod of the spherical fuel reactor is more than that of PWR, which is mainly because the flowing downward of the fuel ball in the reactor vessel is a process of mechanical movement, which has mechanical strength requirements for motion parts. Small control rods obviously do not meet the mechanical strength requirements. Instead, columnar control rods should be used because the diameter is larger. In order to be adapted to the mechanical movement characteristics of the nuclear fuel balls, the cross-sectional shape of the column control rods should be designed into those like circular track, with the side parallel to the direction in which the fuel balls flow into the reactor vessel so as to reduce the flow resistance. If there is solid moderator, the control rods can be placed in the moderator to make columns of high mechanical strength and there is no special requirement for the control rods. Reactor control rods are mounted on a hollow column tube made of high-temperature high-hardness material, wherein the tube wall should be thick and have high mechanical strength. Because of the characteristics of the mechanical movement, the spherical fuel reactor has higher mechanical strength for reactor components. Arrangement of multiple control rod columns inside the reactor vessel may increase the resistance to the flow of spherical solid, resulting in worse liquidity. For a multi-loop reactor, inconsistent spherical solid flow direction can make up the flow properties. Like the pressurized water reactor, the control rods are connected and fixed to each other to form the control rod assembly. The vertical movement of the control rods can control reactivity in the reactor.

The nuclear fuel spherical solid consists of the inner nuclear fuel and the outer cooling agent. The spherical fuel reactor does not need the coolant to continue to be liquid but also allows the coolant for the transition between solid and liquid. For a reactor the power density of which is not high, the solid coolant can be used and it does not require melting of the solid coolant so that some anti-higher temperature materials can be used as coolant and the solid has great bearing ability of external forces and that the ball is not prone to breakage. In case of minor damage, radioactive fission products are more difficult to spread and the solid particle coolant will not flow, which is conducive to the safety system. For low-power reactor, using a solid coolant system can achieve higher intrinsic safety. The solid materials used to make the coolant should be of low neutron cross-section, high thermal conductivity, high specific heat capacity, anti-high temperature and high hardness so that they can still well cover radioactive substances at high temperature. Magnesium oxide, aluminum oxide and silicon carbide are common anti-high-temperature materials. Some composite materials such as metal ceramic and tungsten copper can better meet the requirements. Silicon carbide has a large specific heat capacity, namely 1266.93 J/(kg·k) at 247° C., high thermal conductivity, good temperature resistance and high hardness. It is a solid coolant with good overall performance. The nuclear fuel powder is pressed into nuclear fuel pellets of one or two millimeters in diameter and then covered with anti-high-temperature solid coolant to prepare nuclear fuel balls about 10 millimeters in diameter.

If the solid melting is allowed or to liquid fuel is used, the outermost layer is provided with thick cladding made of anti-high temperature high-strength solid material, and there is support structure between the inner and outer layers to withstand the external force and to prevent external force on the fuel elements. Coolant phase change can greatly improve heat transfer ability. The use of low melting point solid materials as the coolant such as aluminum, magnesium, copper and alloys thereof can significantly reduce the flow. Aluminum is advanced in low neutron cross section, stable chemical properties, high thermal conductivity, high heat capacity, low melting point as well as good coexistence with nuclear fuel. Aluminum can form alloy together with fuel. When aluminum is melted, the nuclear fuel can be free in liquid aluminum to form fusant, which has good heat transfer capacity and is in favor of the system safety. Aluminum can play the role of covering nuclear fuel. Aluminum has low melting point but high boiling point. In case of reactor core melting in serious accident, aluminum can prevent the diffusion of radioactive substances. Aluminum has low melting point and large fusion heat and it is a metal coolant with good overall performance. Aluminum is melted in the reactor and solidified in the steam generator to realize phase change heat transfer, which is important for fast neutron reactor. However, since the liquid aluminum has no mechanical strength, the spherical solid peripheral needs cladding made of anti-high-temperature high-hardness material. Silicon carbide is a good choice. In order to improve the impact resistance of the ball, it needs to set up a support structure in the spherical solid so that the ball has higher hardness. The damage to the ball can cause radioactive liquid effluent. Thus, it is necessary to use good mechanical design to achieve high strength and hardness of the ball. In order to make the coolant have sufficient thermal capacity, it needs a large loading amount of coolant. The capacity needs to be determined according to the actual use of the reactor and it also needs reasonable arrangement for the amount of nuclear fuel and coolant. There are some voids among the spherical solids. Thus, it is necessary to use small coolant balls to fill these voids. The small coolant balls along with the nuclear ball circulate between the reactor and the steam generator by the lifting and transfer devices.

In order to realize better fluidity of the spherical solid particles of the nuclear fuel, the particle size should be as small as possible, which can also prevent collision among the balls. The small balls are light so that the impact force during the collision is small. The solid material has a certain allowable stress limit, and it is easy to change the shape of the small particles. Thus, the fuel ball should be as small as possible, which requires a small quantity of nuclear fuel. Some coolant balls of smaller particles containing no nuclear fuel can be added to the nuclear fuel balls uniformly so as to reduce the accumulation void rate and enhance heat transfer capability. During the flow of the particles, in fact only small particle size of the coolant balls roll on the wall and the nuclear fuel balls nearly do not roll but only follow the movement. Fuel ball diameter is properly about 10 mm, which should be considered comprehensively and determined according to the flow test of the balls.

For thermal neutron reactor, graphite and water can be used as moderator for the spherical fuel reactor. Graphite as the moderator can achieve better inherent security and larger volume. Graphite is made into cylindrical shape and placed inside the reactor vessel. If water is used as the moderator, the reactor volume can be greatly reduced. If heavy water is used, it will be even superior. Water in the reactor is only as the moderator instead of transferring the heat from the reactor. There is an insulating chamber between the fuel pipes and the balls with gas in the middle, so that very little heat can be transferred to water. Water does not vaporize in the reactor vessel, and the pressure is not high. The heat is exported to the outside through the circulation loop.

Under normal operating conditions of spherical fuel reactor, there is a few radioactive fission products, which have been almost cured inside the solid coolant. Even if nuclear fuel ball cracks, only a few radioactive fission products leak.

The steam generator of spherical fuel reactor of the present invention is different from that of the pressurized water reactor (PWR). Its function and structure is very similar to that of the boiler. There are a variety of ways to transfer heat to from the nuclear fuel ball to water. The nuclear fuel balls move on the lifting and transfer devices, wherein the cross-section can be large. Water pipes can be set in the lifting and transfer devices, wherein the parallel water pipes are in the same direction of the movement of the balls. The system is provided with duct system so that the gas flows from the bottom of the lifting and transfer devices to the upper end and heat of nuclear fuel balls is passed to water through thermal radiation, heat conduction and convection gas. If the ball is large in diameter, there can be gaps on the conveyor belt. Gas can pass through the accumulated nuclear fuel balls. The gas and nuclear fuel balls enjoy good heat transfer, which can make the gas flow from the lower side to the upper side of the conveyor belt and pass heat to water. The continuous circulation and thermal radiation can transfer heat to water. If there is sufficient clearance to allow the gas to flow through the balls, the heat can also be exported from the reactor vessel in such way. The nuclear fuel balls move into the steam generator which is provided with many runners, the direction of which is the same as that of the fuel balls. There is water between the runners. The runners are narrow and long and are made of high hardness, abrasion resistance and high thermal conductivity materials so that the heat of the nuclear fuel balls can be passed to water through heat radiation and heat conductivity. Long runners make the steam generator have a large heat transfer area. The volume of the steam generator can be designed to be large. The nuclear fuel balls can stay for a long time in the steam generator so that there is a long residence time for the nuclear fuel balls to pass heat to water. In case of high void ratio of the balls, the gas circulating circuit may be provided to assist the heat transfer. After the gas absorbs the heat of nuclear fuel balls, it will transfer heat to water. In order to improve the heat transfer capability of the coolant as much as possible, aluminum can be encapsulated in the spherical solid coolant particles o make small ball particles of strong thermally conductive ability. The interior part of the steam generator is low-level radioactive. In order to prevent nuclear reaction of nuclear fuel, a lot of strong neutron absorbing materials are placed in it, such as boron and cadmium. The steam generator is a boiler to transfer the heat generated from nuclear reaction to the outside. The nuclear fuel suffers decay in it and emits strong radiation. Therefore, it is a radioactive environment. However, compared with the high neutron flux irradiation in the reactor, the radiation is much smaller. The nuclear fuel balls are of high temperature, which can make the secondary loop achieve high water temperature so as to meet the supercritical requirements. Thus, such reactor can achieve high thermal efficiency. If anti-high temperature materials are used, the nuclear fuel balls will be of higher temperature and it can even drive more efficient Brayton cycle (gas turbine) generators. The setting of secondary heat exchange circuit shielding radiation can also be used for heating, thermo-chemical production of hydrogen, coal liquefaction and gasification.

If the material of low neutron cross-section is used as the coolant, it can reduce the harmful absorption of neutrons and spherical fuel reactor can have a larger value. Especially, in case of the fast neutron reactor, the value growth capacity is strong. The discharged PWR spent fuel can be used as fuel. Some solid materials have very low neutron absorption cross section, and almost absorb no neutron. Such solid coolants can make the low concentration nuclear fuel reach critical condition so that spherical nuclear fuel reactor can fully make use of the nuclear fuel.

The type, concentration and quantity of nuclear fuel in the spherical nuclear reactor and the type and quantity of the coolant as well as the diameter and structure of nuclear fuel balls can be determined in more detail according to the actual use of the reactor.

Mechanical transmission system may suffer faults, causing the balls can not be transferred out of the reactor and that the nuclear fuel inside the reactor can not be cooled so as to lead to core melt accident. There are a large number of solid coolants in the reactor. When the core melts, the coolant and fuel are melted together to form a fusant. The coolant can cover the radioactive materials and prevent their spread to the outside environment. Thus, even in case of serious accident, only a small amount of radioactive materials may leak. Like other types of reactors, spherical fuel reactors can also adopt a lot of active and passive measures to prevent core melt accidents.

Spherical fuel reactor has a unique safety performance, namely that a little energy can move the shutdown fuel balls with a lot of heat into the steam generator. The steam generator has a large amount of water, so that heat can be slowly transferred to water. Even in case of the loss of water of the steam generator, the nuclear fuel balls can be expanded very broad, with a large heat transfer area. The power density of a single ball is not high. The nuclear fuel is dispersed to a large amount of solid coolants so that heat can be transferred through its own heat conduction and heat radiation. The spherical solid particle coolant can also be injected into the water side of the steam generator under the gravity so as to cover the steam generator to form large solid protective barrier.

The residual heat of the reactor can be exported by a variety of ways. Gas heat transfer system similar to the gas cooled reactors can be provided for deriving the reactor core heat in emergency situation. The gas heat transfer system may also be used to absorb gaseous radioactive fission products. The water injection passages may be reserved in the reactor for deriving reactor core heat when the normal heat transfer system fails to operate properly at the time of shutdown of the reactor. The water injection passages are empty during normal operation of the reactor and water is generally not allowed. The reserved water passages can export heat in the same principle as that of the PWR reactors. Stainless steel pipes are provided on the outer wall of the reactor vessel in spiral arrangement. When the core fails in cooling, water can be injected into the pipes to cool the reactor core.

The spherical fuel reactor of the present invention may be designed into a small-power reactor so that it can export heat in passive measures even when all of the passive core residual heat removal systems fail. Due to the low reactor power and low volume power density, the system always has enough heat diffusion ability to export core heat so that the reactor has high inherent safety. High inherent safety is easy to be accepted by people. Thus, such reactor can be more widely applied.

### BRIEF DESCRIPTION OF DRAWINGS

FIG. 1 Schematic diagram of spherical fuel reactor system

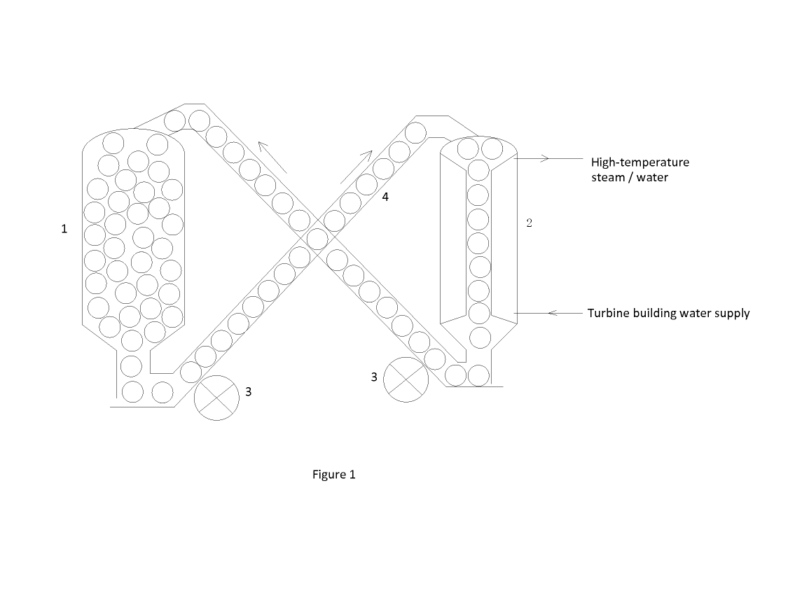

1. Reactor vessel; 2. Steam generator; 3. Motor; 4. Lifting and transfer device;

FIG. 2 Nuclear fuel spherical solid with coolant cladding

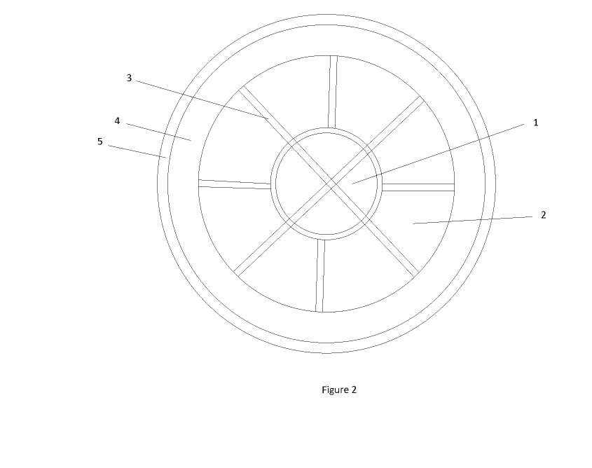

1. Nuclear fuel; 2. Coolant; 3. Support structure; 4. Outer cladding; 5. Metal fiber layer

### EMBODIMENTS

The present invention provides a nuclear reactor which can package the nuclear fuel and the coolant together in a spherical solid and transfer heat to the steam generator through the flow of spherical solid between the reactor and the steam generator by the mechanical transmission system. Such reactor has wide application and can be further designed based on actual use. Especially, if it is designed to be low-power reactor, it will have high inherent safety and can be applied in many fields.

1. A spherical fuel reactor, characterized in that the nuclear fuel and the coolant are packaged together in a spherical solid, wherein the solid coolant can not only cover the radioactive fission products but also cool the nuclear fuel.

2. The spherical fuel reactor according to claim 1, characterized in that the primary circuit system of the reactor consists of a reactor vessel, a steam generator and two sets of spherical solid lifting and transport devices, wherein the lifting and transport devices are used to lift and transport the spherical solid from the lower outlet of the steam generator to the upper inlet of the reactor vessel and from the lower outlet of the reactor vessel to the upper inlet of the steam generator so that the spherical solid circulates between the reactor and the steam generator to transfer the heat generated by the nuclear reaction to the steam generator.

3. The spherical fuel reactor according to claim 1, characterized in that the nuclear fuel spherical solid fuel is a rigid structure composed of an inner nuclear fuel, an outer coolant, a cladding made of peripheral anti-high-temperature high-strength solid and a support between the inner nuclear fuel and the peripheral cladding.

4. The spherical fuel reactor according to claim 1, characterized in that the lifting device is provided with a water pipe inside for absorbing heat from the nuclear fuel ball and a duct system for circulation of gas and transfer of heat from the nuclear fuel ball to the water pipe.

5. The spherical fuel reactor according to claim 1, characterized in that the nuclear fuel ball inside the steam generator transfers the heat to water and there are a number of narrow and long flow passages in the steam generator for fuel to flow through the nuclear fuel ball.
